(19) United States
(12) Patent Application Publication
(10) Pub. No.: US 2002/0198975 A1
(43) Pub. Date: Dec. 26, 2002

(54) Method for managing an appliance

(76) Inventor: Douglas P. Bogia, Hillsboro, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/893,021

(22) Filed: Jun. 26, 2001

(51) Int. Cl. G06F 15/173; G06F 15/16

(52) U.S. Cl. 709/223; 709/206

(57) ABSTRACT

An appliance is configured by sending an electronic data file to the appliance. The appliance is automatically configured based on the electronic data file, which contains configuration information.

### FIELD

The described invention relates to the field of networking. In particular, the invention relates to a method of remotely managing an appliance.

### BACKGROUND

At times, it may be desirable to reconfigure an appliance such as, but not limited to, a server, router, or other configurable electronic device capable of being coupled to a network. Often an administrator manually makes modifications to the configuration. This may involve the administrator locating the appliance over either a local area network (LAN) or wide area network (WAN), coupling to the appliance, navigating to the appropriate configuration page and then submitting the alterations. Additionally, there may be difficulties due to firewall and other security issues.

Oftentimes, a remote user is not able to modify an appliance that is behind a firewall without the assistance of an administrator within the firewall. For example, an on-site administrator typically has to allow a remote user (or administrator) temporary access through the firewall to the appliance. This may be done, for example, by allowing access through the firewall for a limited time (such as 30 minutes) to the remote user's IP address. The remote user can then use an application, such as a browser, to remotely couple with the appliance, and the remote user can then use an interactive menu to modify the configuration of the appliance.

### BRIEF DESCRIPTION OF THE DRAWINGS

FIG. 1 is a schematic diagram that shows a prior art example structure illustrating an appliance coupled to a network.

FIG. 2 is a flowchart showing one embodiment of a technique of managing an appliance, such as via email.

### DETAILED DESCRIPTION

A method of managing an appliance using, for example, an email message, or similar electronic data file, is disclosed. The method provides for easily configuring one or more appliances. In one embodiment, a method of managing an appliance located behind a firewall is described. However, managing an appliance using an email message without navigating around firewall protection is also possible.

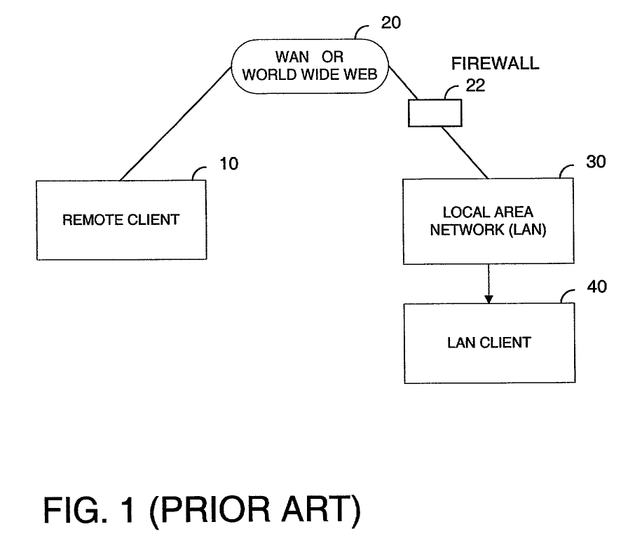

FIG. 1 is a schematic diagram that shows a prior art example structure illustrating an appliance coupled to a network. A remote client 10 is coupled to a Wide Area Network (WAN) 20, or other network such as the World Wide Web. Similarly, a local area network 30 is coupled to the WAN 20. In one embodiment, the LAN 30 comprises a small office network and is isolated from the WAN 20 by a firewall 22. A LAN client 40 is coupled to the LAN 30.

In one embodiment, LAN client 40 comprises the appliance to be managed. However, other appliances coupled to the WAN 20 or LAN 30 may be managed similarly. Additionally, an appliance may be managed by a client coupled to the same LAN. An appliance may comprise a server, router, personal digital assistant, computer hardware, or other configurable electronic device that can receive email or other electronic data files via a network, or has access to an email server. In one embodiment, the firewall 22, LAN 30, and LAN client 40 may be integrated together, and any combination of firewall 22, LAN 30 and LAN client 40 may be managed as described herein.

In one embodiment, configuring the appliance may include modifying the operating system or an application program running on an appliance. In this way, the operating system and/or application program behaves differently than it did before the configuration change. For example, a particular section of code may be executed in response to the modification.

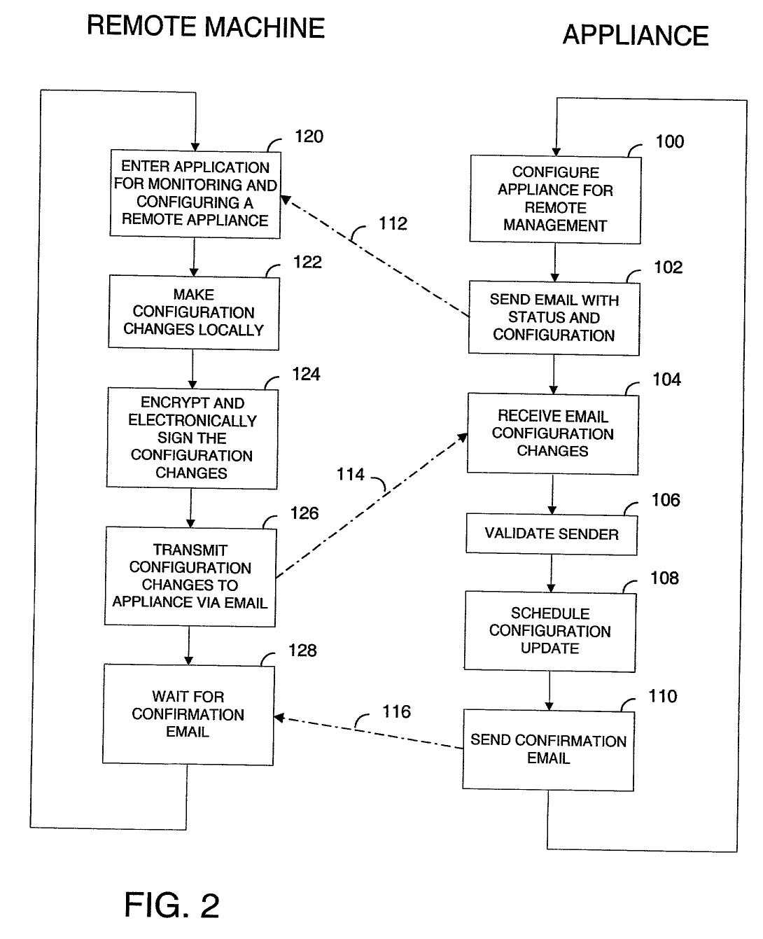

FIG. 2 is a flowchart showing one embodiment of a technique of managing an appliance, such as via email. The flowchart begins at block 100, at which the appliance is set up to be remotely managed via a remote machine. This may include setting up a set of electronic signatures for remote users who are allowed to make modifications to the appliance, as well as specifying what types of modifications can be made. In one embodiment, remote users have different access authority levels and can only modify configuration parameters within their access authority.

The flowchart continues at block 102, at which an email, or other electronic data file, is sent out denoted by 112 indicating the status of the appliance. This may be performed at periodic time intervals, or may be performed when the appliance detects a problem. Other approaches may also be used.

The flowchart proceeds to block 104, at which the appliance waits until it receives an email, or other electronic data file, containing configuration changes. In one embodiment, the appliance receives the email configuration changes by its email server. Firewall 22 does not block email messages sent to the appliance. It is up to the appliance to appropriately screen the email messages for configuration changes. In one embodiment, an email containing, for example, a specific pattern, code, user identifier, or key word in the subject line, header, or other field indicates that the email message contains configuration information. Other approaches may also be employed.

The configuration information may be implemented in numerous ways as long as the appliance and the remote machine “understand” each other. In one embodiment, the configuration changes are included in an email formatted using a definable data structure, such as extensible Markup Language (XML), or XML combined with a proprietary protocol. In another embodiment, the configuration information comprises text fields separated by a tab, comma, or other delimiter. Again, many other approaches may also be employed.

The appliance validates that the sender (e.g., a remote user) is authorized to make changes, at block 106. This may be done, for example, by verifying a digital signature, as is well-known in the art. The appliance also decrypts the email, if it was encrypted by the sender. Other encryption and decryption approaches are also possible, of course.

After the appliance validates that the sender is authorized to make configuration changes, the configuration update is scheduled at block 108. In one embodiment, the configuration is updated substantially immediately. In another embodiment, the configuration is updated at a time when the appliance is idle, or when there is very little processing being done by the appliance. In yet another embodiment, the configuration is updated at a predetermined time. For example, configuration changes may be performed at a particular time on an hourly, daily, weekly, and/or monthly basis. Other approaches may also be employed.

In one embodiment, after the configuration is changed, the process flow continues at block 110, at which an email 116, or other electronic data file, indicating whether the configuration change was successful or not is optionally sent to the remote machine that initiated the configuration change. The appliance may then loop back to block 100 to modify the remote management configuration. Alternatively, the appliance may skip block 100 and loop back to block 102.

On the remote machine, at block 120, an application for monitoring and configuring a remote appliance is activated. In one embodiment, a user activates the application. In another embodiment, the application runs in the background of the remote machine, and becomes active responsive to receiving an email 112, or other electronic data file, from the appliance. Other approaches are also possible.

At block 122, a local application on the remote machine formats the emails, or other electronic data files, received from the appliance into a format the user (or administrator) may easily understand and modify. The user (or administrator) may make configuration changes, and the configuration changes may be re-formatted in an email, or other electronic data file, in a way that the appliance may process. In one embodiment, the configuration changes are kept locally on the remote machine until the email is ready to send to the appliance.

At block 124, the email of the configuration changes is encrypted and electronically signed, and the email is transmitted 114 to the appliance at block 126. Of course, other approaches are possible. The remote machine may then wait for a confirmation email back from the appliance at block 128. The remote machine's application for modifying configuration information may then become idle until other modifications of remote appliances are initiated at block 120.

Various other embodiments of the above description are also possible. For example, sending an email with status and configuration at block 102 may be skipped, and the appliance may respond to incoming email configuration changes without sending a prior configuration status. Additionally, although the above description focused on a remote machine managing an appliance, the managing machine may actually be on the same network, or otherwise capable of transmitting and receiving with the managed appliance without “crossing” a firewall.

Moreover, the described process may be applied to multiple machines. For example, the remote machine may transmit an email message, or other electronic data file, to multiple appliances at substantially the same time. This allows the remote machine to easily keep a group of appliances consistently configured. It may also be much quicker than coupling to individual appliances and changing the appliances in a serial fashion.

In yet another embodiment, the remote machine sends an email to the appliance to configure the appliance to open “a hole” in the firewall to the remote machine's IP address. After “the hole” in the firewall is opened, the remote machine may interactively monitor and modify the appliance. The IP address may be conveyed directly via the email, or alternatively, the email may include a user identifier that identifies to the appliance the IP address of the remote machine. For example, the appliance may include a look up table of users and their corresponding IP addresses.

Thus, a method of managing an appliance using an email or other electronic data file is disclosed. However, the specific embodiments and methods described herein are merely illustrative. Numerous modifications in form and detail may be made without departing from the scope of the invention as claimed below. Rather, the invention is limited only by the scope of the appended claims.

What is claimed is:

1. A method of configuring an appliance comprising:
sending an electronic data file containing configuration information to the appliance; and
automatically configuring the appliance in response to receiving the electronic data file.

2. The method of claim 1, wherein the configuration information is in a markup language.

3. The method of claim 2, wherein the configuration information is in XML.

4. The method of claim 1, wherein the electronic data file is embedded in an email, and further comprising:
encrypting the electronic data file prior to sending it to the appliance.

5. The method of claim 4 further comprising:
decrypting the email after being received by the appliance.

6. The method of claim 5 further comprising:
authenticating the email after being received by the appliance.

7. The method of claim 6 further comprising:
checking that the email has a proper authorization before configuring the appliance.

8. The method of claim 1 further comprising:
allowing access through a firewall to a particular IP address in response to receiving the electronic data file.

9. The method of claim 8 further comprising:
allowing the particular IP address to modify the appliance through an interactive session.

10. The method of claim 1 further comprising:
authenticating the electronic data file by the appliance.

11. A method of configuring an appliance comprising:
receiving an email containing configuration information; and
configuring the appliance based on the configuration information.

12. The method of claim 11 further comprising:
decrypting the email.

13. The method of claim 11 further comprising:
authenticating the configuration information.

14. The method of claim 13 further comprising:
allowing access through a firewall to a particular IP address responsive to receiving the email.

15. The method of claim 14 further comprising:
allowing access by the particular IP address to the appliance via an interactive menu.

16. The method of claim 15, wherein the interactive menu is part of a browser.

17. The method of claim 11 further comprising:
sending a confirmation email indicating that the appliance was reconfigured successfully.

18. A method of configuring multiple appliances comprising:
sending an email containing configuration information for multiple appliances; and
the multiple appliances configuring themselves based on the configuration information.

19. The method of claim 18 further comprising:
encrypting the configuration information in the email.

20. The method of claim 19 further comprising:
the multiple appliances authenticating the email before configuring themselves based on the configuration information.

21. The method of claim 18 further comprising:
the multiple appliances authenticating the email before configuring themselves based on the configuration information.

22. A method of communicating with a network comprising:
receiving an email containing a user identifier; and
allowing access through a firewall of the network to an IP address corresponding to the user identifier in response to receiving the email.

23. The method of claim 22 further comprising:
authenticating the email.

24. The method of claim 22 further comprising:
decrypting the email.

25. The method of claim 22, wherein access through the firewall is allowed for a predetermined time interval.

26. The method of claim 22 further comprising:
sending a confirmation email indicating that access was allowed through the firewall.

27. The method of claim 22, wherein the user identifier is the IP address.

28. The method of claim 27, wherein access through the firewall is allowed for a predetermined time interval.

29. An article comprising:
a storage medium which stores instructions, the instructions, when executed, causing systems to:
receive an electronic data file containing configuration information; and
configure an appliance based on the configuration information.

30. The article of claim 29, wherein the storage medium further comprises instructions, the instructions, when executed, cause systems to:
decrypt the electronic data file.

31. The article of claim 29, wherein the storage medium further comprises instructions, the instructions, when executed, cause systems to:
authenticate the configuration information.
